(19) United States
(12) Patent Application Publication
(10) Pub. No.: US 2006/0072908 A1
(43) Pub. Date: Apr. 6, 2006

(54) On-the-fly CRC parity generation and scrambling in DVD storage devices

(76) Inventors: Tsung-Ming Ho, Hsinchu (TW); Fang-Ming Kuo, Hsinchu (TW); Hsin-Lung Yang, Hsinchu (TW)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(21) Appl. No.: 10/954,296

(22) Filed: Oct. 1, 2004

(51) Int. Cl. H04N 5/781

(52) U.S. Cl. 386/124; 386/125

(57) ABSTRACT

A digital video disc (DVD) recording device including an interface for communicating between the DVD recording device and a host, an error detection code (EDC) generator receiving data sent directly from the interface and generating a data frame by adding an EDC to the data, and a scrambler for scrambling the data frame sent directly from the EDC generator.

### FIELD OF THE INVENTION

This invention pertains in general to an optical recording and reproducing medium, and more particularly, to a digital video disc (“DVD”) recording device and system.

### BACKGROUND OF THE INVENTION

The digital video disc or digital versatile disc (“DVD”) “family” presently includes DVD-Video, DVD-R (DVD-Recordable) and DVD-RW (DVD-Rewritable). DVD-Video is designed for a playback purpose, i.e., reproduction, only, DVD-R allows information to be recorded thereon once only, and DVD-RW has the feature that information can be repetitively recorded thereon a plurality of times. For a recordable or rewritable DVD, it is possible to digitally copy the whole content of a moving picture, including image, voice and the like onto the DVD. Often, the contents recorded as digital data on a DVD are protected by copyrights to deter unauthorized copying. One of the countermeasures against illegal copying is the use of data scramble. Digital data that is scrambled cannot easily be reproduced unless the scramble is removed.

A procedure to generate a scrambled frame is specified in DVD Specification for Recordable Disc for General Part 1 Physical Specification Version 2.01. To begin, identification data (“ID”) are generated and added to an ID error detection code (“IED”). The ID plus IED, main data or main information to be protected, and copyright management information (“CPR-MAI”) are then added with an error detection code to form a data frame before scrambling. FIG. 1 is a block diagram of a known DVD recording system 10 configured in accordance with the above-mentioned DVD specification. Referring to FIG. 1, DVD recording system 10 includes a DVD recording device 12, a host 14 and a memory device 16. DVD recording device 12 may include an ID generator 121, an IED generator 122, a CPR-MAI generator 123, an error correction code (“ECC”) encoder 124, a scrambler 125, an error detection code (“EDC”) generator 126 and an advanced technology attachment packet interface (“ATAPI”) 127.

In operation, host 14 transmits main data to DVD recording device 12 through ATAPI 127. The main data are stored in memory device 16. An ID from ID generator 121 is added to an IED provided by IED generator 122. IED generator 122 transmits a resulting code including the ID and IED to EDC generator 126. CPR-MAI generator 123 transmits a CPR-MAI to EDC generator 126. Receiving the code including the ID and IED and the CPR-MAI, EDC generator 126 retrieves the main data from memory device 16, adds an EDC to the code, CPR-MAI and main data to provide a data frame, and then stores the data frame to memory device 16. Scrambler 125 retrieves the data frame and scrambles the same to provide a scrambled frame. Subsequently, ECC encoder 124 retrieves the scrambled frame for further treatment. DVD recording system 10 is disadvantageous in that multiple accesses to memory device 16 are required, which may require a higher clock frequency and a higher bandwidth, and in turn may result in higher power consumption. It is thus desirable to have a DVD recording system or device that achieves data scrambling with reduced memory access.

### BRIEF SUMMARY OF THE INVENTION

The present invention is directed to a device and a system that obviate one or more problems resulting from the limitations and disadvantages of the prior art.

In accordance with an embodiment of the invention, there is provided a digital video disc (DVD) recording device that comprises an interface for communicating between the DVD recording device and a host, an error detection code (EDC) generator receiving data sent from the interface and generating a data frame by adding an EDC to the data, and a scrambler for scrambling the data frame sent from the EDC generator.

Also in accordance with the present invention, there is provided a digital video disc (DVD) recording device that comprises an advanced technology attachment packet interface (ATAPI) for receiving main data, an error detection code (EDC) generator receiving the main data sent from the ATAPI and generating a data frame by adding an EDC to the main data, a memory device, and a scrambler for scrambling the data frame sent from the EDC generator and storing a scrambled frame in the memory device.

Further in accordance with the present invention, there is provided a digital video disc (DVD) recording system that comprises a computer providing main data, an interface, an error detection code (EDC) generator receiving main data sent from the computer through the interface and generating a data frame by adding an EDC to the main data, a scrambler for scrambling the data frame sent from the EDC generator, and a memory device storing a scrambled frame sent from the scrambler.

Additional features and advantages of the present invention will be set forth in part in the description which follows, and in part will be obvious from the description, or may be learned by practice of the invention. The features and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate one embodiment of the present invention and together with the description, serves to explain the principles of the invention.

### BRIEF DESCRIPTION OF THE DRAWINGS

Reference will now be made in detail to the present embodiment of the invention, an example of which is illustrated in the accompanying drawings. Wherever possible, the same reference numbers are used throughout the drawings to refer to the same or like parts.

FIG. 1 is a block diagram of a digital video disc (“DVD”) recording system configured in accordance with known DVD specifications; and

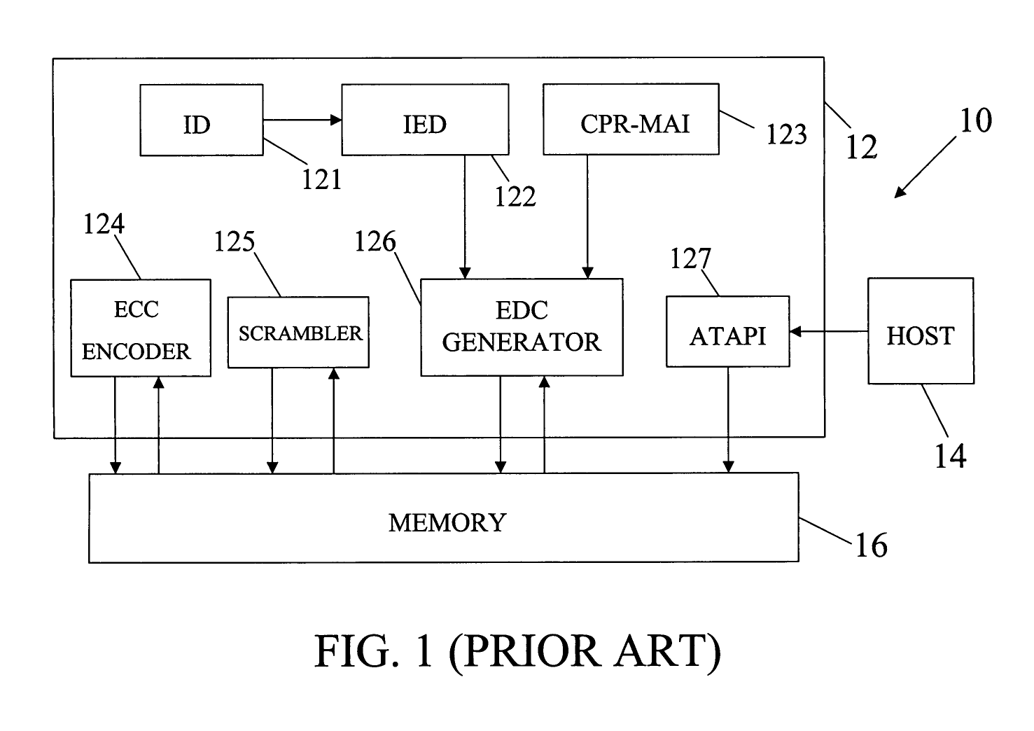

FIG. 2 is a block diagram of a DVD recording system in accordance with an embodiment of the present invention.

### DETAILED DESCRIPTION OF THE INVENTION

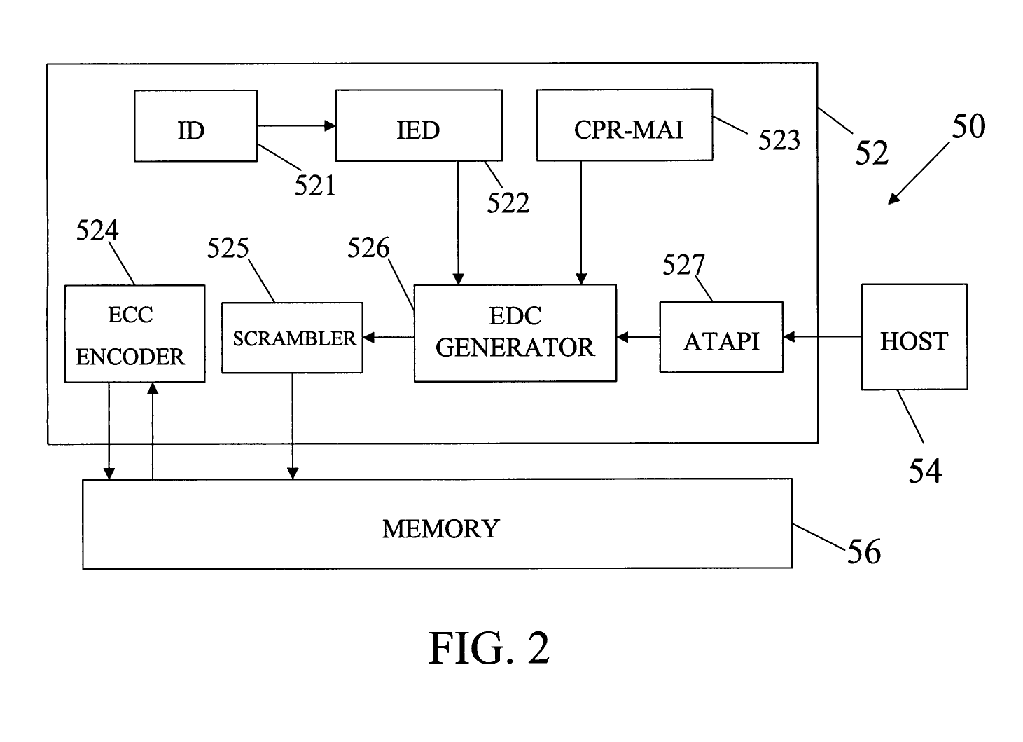

FIG. 2 is a block diagram of a digital video disc (“DVD”) recording system 50 in accordance with an embodiment of the present invention. Referring to FIG. 2, DVD recording system 50 includes a DVD recording device 52, a host 54 and a memory device 56. DVD recording device 52, for example, a DVD rewritable device, further includes an identification data (“ID”) generator 521, an ID error detection code (“IED”) generator 522, a copyright management information (“CPR-MAI”) generator 523, an error correction code (“ECC”) encoder 524, a scrambler 525, an EDC generator 526 and an interface 527. Host 54 includes an external apparatus such as a computer for providing main data. Memory device 56 includes static random access memory (“SRAM”) or dynamic random access memory (“DRAM”). In one embodiment according to the present invention, interface 527 includes an advanced technology attachment packet interface (“ATAPI”) for data communications with host 54.

In operation, ID generator 521, for example, a register or a counter, generates an ID which contains attributes and a physical address of DVD recording device 52. IED generator 522, controllable by a central processor unit (not shown), generates an IED. The ID from ID generator 521 is sent to IED generator 522 and added to the IED to form a code. The code can be decoded to detect as well as to correct errors in the ID. CPR-MAI generator 523 generates a CPR-MAI which contains copyright information corresponding to main data to prevent the contents of the main data from being illegally copied. The ID plus IED code and the CPR-MAI are sent to EDC generator 526. The main data are provided from host 54 through interface 527 to EDC generator 526. EDC generator 526 generates an EDC, which is a cyclic redundancy check code, and provides a data frame by attaching the EDC to the ID, IED, CPR-MAI and main data before scrambling. Scrambler 525 scrambles the data frame, for example, by a logical exclusive-or function, to provide a scrambled frame, and then stores the scrambled frame to memory device 56. ECC encoder 524 subsequently retrieves the scrambled frame from memory device 56 for encoding the same into an ECC block.

In an aspect of the present invention, the data frame provided by EDC generator 526 includes 2048 bytes of main data, 6 bytes of ID plus IED, 6 bytes of CPR-MAI and 4 bytes of EDC. In another aspect, memory device 56 is embedded into DVD recording device 52.

As will be appreciated by those skilled in the art, the present invention reduces the number of times memory 56 must be accessed, thereby making it possible to decrease bandwidth and reduce clock speed and, thus, reduce power consumption.

The foregoing disclosure of the preferred embodiments of the present invention has been presented for purposes of illustration and description. It is not intended to be exhaustive or to limit the invention to the precise forms disclosed.

Many variations and modifications of the embodiments described herein will be apparent to one of ordinary skill in the art in light of the above disclosure. The scope of the invention is to be defined only by the claims appended hereto, and by their equivalents.

What is claimed is:

1. A digital video disc (DVD) recording device, comprising:
an interface for communicating between the DVD recording device and a host;
an error detection code (EDC) generator for receiving data sent directly from the interface and generating a data frame by adding an EDC to the data; and
a scrambler for scrambling the data frame directly sent from the EDC generator.

2. The device of claim 1 further comprising an error correction code (ECC) encoder for encoding a scrambled frame.

3. The device of claim 2 comprising a memory device for storing an ECC.

4. The device of claim 1 further comprising a memory device for storing a scrambled frame sent from the scrambler.

5. The device of claim 1, wherein the interface includes an advanced technology attachment packet interface (ATAPI).

6. The device of claim 1, wherein the EDC generator receives a code formed by identification data (ID) and an ID error detection code (IED).

7. The device of claim 1, wherein the EDC generator receives a copyright management information (CPR-MAI).

8. A digital video disc (DVD) recording device, comprising:
an advanced technology attachment packet interface (ATAPI) for receiving main data;
an error detection code (EDC) generator for receiving the main data sent directly from the ATAPI and generating a data frame by adding an EDC to the main data;
a memory device; and
a scrambler for scrambling the data frame sent directly from the EDC generator and storing a scrambled frame in the memory device.

9. The device of claim 8, further comprising an identification data (ID) generator for generating an ID.

10. The device of claim 8, further comprising an identification data (ID) error detection code (IED) generator for generating a code including the ID and the IED.

11. The device of claim 8, further comprising a copyright management information (CPR-MAI) generator for generating a CPR-MAI.

12. The device of claim 8, wherein the EDC generator receives a code formed by identification data (ID) and an ID error detection code (IED).

13. The device of claim 8, wherein the EDC generator receives a copyright management information (CPR-MAI).

14. The device of claim 8, further comprising an encoder for encoding the scrambled frame.

15. A digital video disc (DVD) recording system, comprising:
a computer providing main data;
an interface;
an error detection code (EDC) generator for receiving main data sent from the computer through the interface and generating a data frame by adding an EDC to the main data;
a scrambler for scrambling the data frame sent directly from the EDC generator; and
a memory device for storing a scrambled frame sent from the scrambler.

16. The system of claim 15, further comprising an error correction code (ECC) encoder for encoding a scrambled frame.

17. The system of claim 16, wherein the memory device storing an ECC sent from the ECC encoder.

18. The system of claim 15, wherein the interface includes an advanced technology attachment packet interface (ATAPI).

19. The system of claim 15, wherein the EDC generator receives a code formed by identification data (ID) and an ID error detection code (IED).

20. The system of claim 15, wherein the EDC generator receives a copyright management information (CPR-MAI).
